(19) United States
(12) Patent Application Publication
(10) Pub. No.: US 2004/0075342 A1
(43) Pub. Date: Apr. 22, 2004

(54) Boat ignition safety apparatus and method

(76) Inventors: Craig D. Feldman, Stow, OH (US); Robert T. Allison III, Akron, OH (US); Russell A. Hercules, Cuyahoga Falls, OH (US); Roy P. Kessell, Cuyahoga Falls, OH (US)

Correspondence Address: Larry B. Donovan, 1111 Leader Building, 526 Superior Avenue, Cleveland, OH, 44114, US

(21) Appl. No.: 10/618,530

(22) Filed: Jul. 10, 2003

Related U.S. Application Data
(63) Continuation-in-part of application No. 09/950,032, filed on Sep. 10, 2001, now Pat. No. 6,670,722.
(60) Provisional application No. 60/394,884, filed on Jul. 10, 2002.

(51) Int. Cl. H02G 3/00; B60L 3/00; B60L 1/00

(52) U.S. Cl. 307/10.1

(57) ABSTRACT

A boat ignition safety apparatus and method are disclosed. A vapor sensor can detect an amount of vapor fumes within an associated compartment and a blower associated with the compartment is operative to exhaust gas therefrom. A controller controls the blower based on the amount of vapor fumes within the associated compartment, which further can include operation for a period of time even after the ignition has been turned off.

### RELATED APPLICATIONS

This application claims the benefit of U.S. Provisional Patent Application No. 60/394,884, which was filed on Jul. 10, 2002. This application claims the benefit of U.S. application Ser. No. 09/950,032, filed on Sep. 10, 2001, which claims the benefit of U.S. application Ser. No. 09/634,432, filed on Aug. 8, 2000, which claims the benefit of U.S. Provisional Application No., 60/147,797, filed on Aug. 9, 1999. The present invention is also the subject of Disclosure Document No. 455,716 dated Apr. 26, 1999, which was received by the U.S. Patent and Trademark Office on Apr. 30, 1999. The specification of each of the above-referenced applications is incorporated herein by reference.

### TECHNICAL FIELD

The present invention relates to marine safety equipment, and more particularly to a safety apparatus and method that prevents ignition of a boat's gasoline engine until an engine compartment has received proper ventilation for a predetermined period of time.

### BACKGROUND OF THE INVENTION

Boats are generally powered by gasoline engines, which are typically mounted in enclosed compartments in either a boat's hull, or in an area toward its stern. As a result, when the engine is not in operation, volatile fumes from the fuel emanate from the engine and its surrounding components. These fumes quickly accumulate within the enclosed engine compartment reaching a concentration substantial enough to become a hazard for explosion. Furthermore, because of the mechanical and electrical components involved in a combustion engine, it is very likely that electrical charges or sparks may be emitted throughout the surrounding engine compartment. Because of the engine compartment's volatile environment, conditions are highly conducive for the occurrence of an explosion. To prevent these fumes from exploding when the engine is started, the gas fumes must be exhausted from the engine compartment prior to starting the boat's engine. If the enclosed engine compartment is not properly exhausted, safety concerns could arise.

Today, all boats that have inboard motors include a fan in the engine compartment for exhausting fuel fumes. Further, current federal regulations and safety operating guidelines suggest using a powered ventilation system for at least four minutes before a boat is started However, boaters are not likely to be aware of how long to ventilate the engine compartment to properly prevent the concentration of hazardous fuel fumes In addition, many boaters may unintentionally forget to turn on the ventilation fan, if they are not reminded to do so in some fashion. Finally, ether boaters may intentionally avoid activating the exhaust fan if they have the ability to start the engine independently of the exhaust fan

### SUMMARY OF THE INVENTION

The present invention is directed to a boat ignition safety apparatus and method which prevents the engine of a boat. One aspect of the present invention relates to a system to facilitate safe operation of a vehicle that includes a vapor sensor operative to detect an amount of vapor fumes within an associated compartment. A blower is operative operatively associated with the compartment to facilitate exhausting ambient therefrom. A controller controls the blower based on the amount of vapor fumes within the associated compartment. In one particular aspect, the controller can implement a timer to enable operation of the sensor and/or the blower for a predetermined time period after ignition has been turned off.

The advantages that the present invention provides in terms of functionality and utility will be further made apparent when the detailed description is read in conjunction with the applicable drawings and claims.

### BRIEF DESCRIPTION OF THE DRAWINGS

FIG. 1 is a block diagram of the general functionality of the boat ignition safety apparatus.

FIG. 2 is a schematic diagram of the boat ignition safety apparatus of the present invention.

FIG. 3 is a perspective view of a boat equipped with the boat ignition safety apparatus of the present invention with the engine compartment shown partially cut-away.

FIG. 4 is a schematic diagram of an alternate embodiment of the boat ignition safety apparatus.

FIG. 5 is a schematic diagram of the embodiment in FIG. 4 showing internal and external wiring connections for the present invention.

FIG. 6 is a schematic diagram of an alternate embodiment of the boat ignition safety apparatus.

FIG. 7 is a schematic diagram of an alternate embodiment of the boat ignition safety apparatus.

FIG. 8 is a schematic diagram of an alternate embodiment of the boat ignition safety apparatus

FIG. 9 is a schematic diagram of an alternate embodiment of the boat ignition safety apparatus.

FIG. 10 is an elevational view showing an air pressure sensor used in the boat ignition safety apparatus to detect positive air flow within an engine compartment.

FIG. 11 is an elevational view showing an air pressure sensor coupled to an in-line blower motor in one embodiment of the present invention.

FIG. 12 is an example of a vapor sensor circuit in accordance with an aspect of the present invention.

FIG. 13. is an example of boat safety apparatus that can be implemented in accordance with an aspect of the present invention.

FIG. 14 is a flow diagram illustrating a methodology for controlling operation of safety components in accordance with an aspect of the present invention.

### DETAILED DESCRIPTION

In the following detailed description of embodiments of the present invention reference is made to the accompanying drawings which, in conjunction with this detailed description, illustrate and describe an apparatus for preventing a boater from starting an engine until a ventilation fan has removed volatile fumes from an engine compartment. The invention may also be embodied in many different forms and should not be construed as limited to only the disclosed embodiments. The provided embodiments are included so the disclosure will be thorough, complete and will fully convey the scope of the invention to persons of ordinary skill in the art.

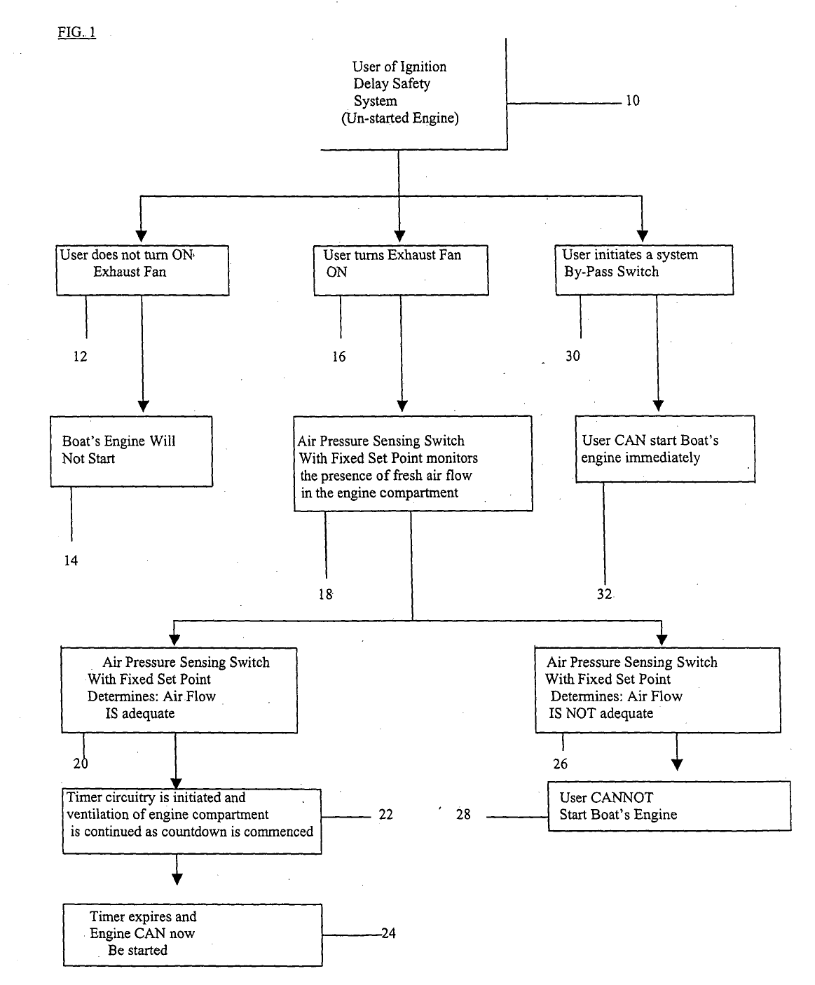

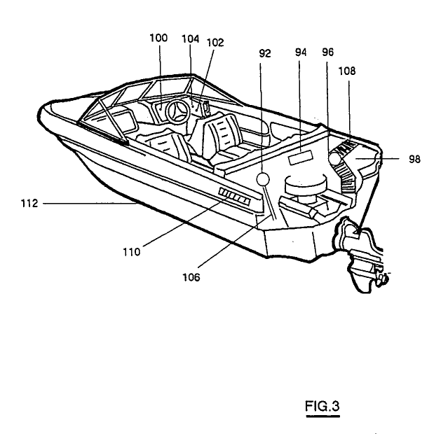

FIG. 1 is a block diagram of the general functionality of the boat ignition safety apparatus 10. When preparing to start a boat's engine, the first step is for the user to turn on 16 the ventilator. In one example embodiment, the ventilator comprises an exhaust or ventilation fan 92 (see FIG. 3) fan 92, then the engine will not start 14 If the user does not turn on 12 the exhaust In an alternate embodiment, not only will the engine not start 14 but the exhaust or ventilation fan 92 will be automatically turned on After the user turns on 16 the exhaust fan 92 (or it is turned on automatically), an air pressure sensor 96 (see FIG. 3) monitors 18 the presence of positive air flow in the engine compartment 98. The air pressure sensor 96 determines whether the exhaust fan 92 is clearing the engine compartment 98 of volatile gasoline fumes.

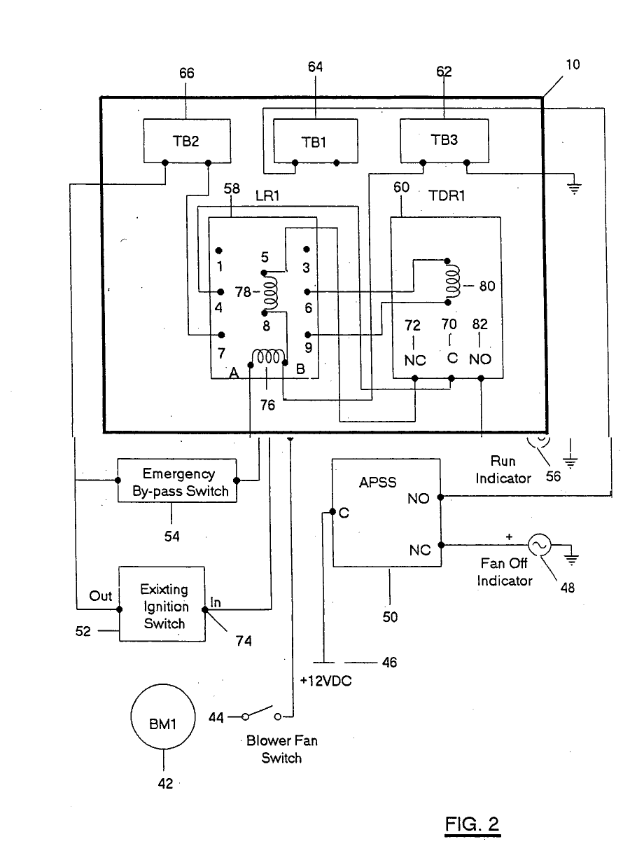

FIGS. 2, 4 and 5 show similar air pressure sensors 50 and 126 Reference numerals 50, 96 and 126 are used interchangeably to refer to air pressure sensing switches because the present invention uses the switches that are triggered by variations in air pressure of ordinary skill in the art would understand that separate air pressure sensors and switches could be used in place of an air pressure sensing switch.

In an example embodiment, air pressure sensor 96 is an air pressure sensing switch such as Model RSS-495—sold by Cleveland Controls. The air pressure sensing switch is comprised of a housing containing a diaphragm and a snap-acting switch Barbed sample line connectors on each side of the diaphragm accept flexible 5 tubing. The snap-action switch can be actuated by a positive or negative pressure, or by a pressure differential. The switch includes normally open, normally closed and common connect terminals. The air pressure sensing switch has an adjustable set point range that is set to a predetermined set point for use in the present invention. To adjust the sensitivity of the air pressure sensor 96, the adjustable set point of the air pressure sensing switch can be altered. In the boat ignition safety apparatus 10 of the present invention, the air pressure sensor, implemented with an air pressure sensing switch, is configured to detect positive pressure within an engine compartment. When fresh air is drawn into an engine compartment by a ventilation fan or blower in order to flush fumes out from the engine compartment, a positive pressure develops within the engine compartment. This positive pressure is detected by the air pressure sensor and indicates that the ventilation fan or blower is operating properly.

Use of an air pressure sensor in the present invention provides a number of advantages over prior art boat ignition safety devices. In particular, prior art boat ignition safety devices were adversely affected by the direction of air flow, the devices orientation and forces applied to the prior art devices due to acceleration and deceleration Because the present invention includes an air pressure sensing switch it can detect air flow from all directions. Prior art devices use a sail and cam arrangement that will only trigger a separate switch if air flows in one direction to push the sail and cam into the switch.

Another advantage provided by the use of an air pressure sensing switch is that it can be mounted within the boat in almost any orientation, making the boat ignition safety apparatus easily adaptable to different types of boats. Prior art devices, such as that disclosed in U.S. Pat. No. 5,050,520, will only detect air flow if the mechanical sensory device, made up of a sail, cam and switch, are within a horizontally mounted vent tube. If the vent tube where mounted vertically with the intake side of the vent tube upward, the position of the sail changes and triggers the switch. If the intake side of the tube were mounted vertically with the intake side of the tube downward, the position of the sail changes away from the switch and never triggers the switch. The prior art devices requires that the vent tube always be positioned so that air flow works the sail properly. The use of an air pressure sensing switch in the present invention does not depend on a sail, cam and switch arrangement, only the detection of positive air pressure. Therefore, the air pressure sensing switch can be mounted in any position, making the device much more convenient to mount and/or retrofit in boats.

A further advantage of the use of an air pressure sensing switch in the present invention is that it is unaffected by forces due to acceleration and deceleration of the boat. Because the prior art devices use a mechanical sensory device, i.e., a sail, cam and switch, they have mass, which a sudden force from acceleration or deceleration could activate due to inertia. For example, if a boat were to slam into a wave or surf down the face of a wave, this motion would cause a change in the position of the sail and thereby detect forces of acceleration rather than air flow. Because the present invention monitors and detects air pressure, the detection method has little mass and forces due to acceleration and deceleration do not affect the results.

Once an adequate flow of air is detected 20 within the engine compartment 98, verifying that the exhaust or ventilation fan 92 is operating properly, a predetermined time delay begins 22. During the predetermined time delay, the exhaust fan 92 maintains the flow of fresh air through the engine compartment 98. During the predetermined time delay, the engine of the boat is disabled and may not be started. Once the predetermined time delay expires, boat ignition safety apparatus 10 again allows the engine of the boat to be started 24. However, in the event the air pressure sensor 96 (see FIG. 3) determines that the air flow is not adequate 26 to remove the gasoline or other fumes from the engine compartment 98, the user is prevented from starting 28 the engine. Unless the air pressure sensor 50 detects adequate air flow for the duration of the predetermined time delay, the engine will not be allowed to start. For example, if half way through the predetermined time delay the air pressure sensor 50 no longer detects positive air flow in the engine compartment 98, the predetermined time delay will be reset and start over upon the next detection of positive air flow by air pressure sensor 50.

Additionally, a user also has the option in an emergency to by-pass the boat ignition safety apparatus 10 by actuating a by-pass safety switch 30. By activating the by-pass switch 30, the user can immediately start 32 the engine present invention allows the user to start the engine immediately. This feature of the This can be advantageous in that it allows the user to avoid a collision with another boat or other source of imminent danger. To provide as much safety as possible to boaters, in an alternate embodiment of the by-pass function the exhaust or ventilation fan 92 is automatically started or remains operating upon actuation of the by-pass switch 30. This provides for some ventilation in an emergency, which is always preferable to no ventilation. While safety dictates that there be some means for by-passing the boat ignition safety apparatus 10, having a by-pass safety switch 30 can be an invitation for abuse by impatient boaters.

To help protect boaters from themselves, a further contemplated embodiment of the by-pass safety switch 30 includes a time limitation on its use imposed by the boat ignition safety apparatus 10. Thus, when the by-pass switch 30 has been engaged the engine would only operate for a predetermined time period sufficient to avoid an emergency. Although not shown, one of ordinary skill in the electronic arts will recognize that the by-pass time limitation function could be implemented using circuitry similar to that used for the delay function shown in FIGS. 2 and 4-9.

FIG. 2 is a schematic diagram of the boat ignition safety apparatus of the present invention The boat ignition safety apparatus 10 is comprised of an ignition switch 52 that when actuated, applies +12V DC 46 to terminal block 2 (TB2) 66, terminal 7 of latching relay 1 (LR1) 58 and to fan off indicator lamp 48. Instead of an ignition switch, apparatus 10 could include a sensor that detects when a preexisting ignition switch or actuator of a boat is initiated. This sequence of events has the effect of preventing the engine from being started until air flow has been proven to be adequate at air pressure sensor (APSS) 50. To initiate the boat ignition safety apparatus 10 and start the boat, the user must actuate blower fan switch 44, which engages the blower motor (BM1) 42.

In an alternate embodiment, apparatus 10 detects the actuation of ignition switch 52 and automatically engages blower motor 42. The blower motor 42 provides positive air flow and a positive air pressure within the engine compartment, which is detected by air pressure sensing switch 50 causing the contacts of the air pressure sensing switch 50 to close and the fan indicator lamp 48 to turn off. When the contacts of air pressure sensing switch 50 close, +12VDC 46 is applied to both terminal block 1 (TB1) 64 and terminal A 76 of latching relay 58. Furthermore, terminals 4 and 7 of latching relay 58 close applying +12VDC 46 to time delay relay (TDR1) 60, common node 70, normally open terminal 82 and terminal 8 of latching relay 58, which activates coil 78. Activating coil 78 has the effect of closing terminals 6 and 9 of latching relay 58, which activates 9 coil 80 of time delay relay 60 and initiates the preset four (4) minute time delay of the apparatus 10. The relay logic, or combination of latching relays and time delay relays, is primarily responsible for controlling the functions of the boat ignition safety apparatus 10. In order to complete the preset four (4) minute timing cycle, air pressure sensing switch 50 must detect positive air flow in the form of positive air pressure for the full timing cycle otherwise the sequence is repeated until positive air flow is detected for the entire timing cycle.

Once the preset four (4) minute timing cycle is completed, time delay relay 60 opens normally closed terminal 72 and closes normally open contact 82, Next, +12VDC 46 is applied to terminal 74 of ignition switch 52 and illuminates run indicator lamp 56 thereby allowing the boat's engine to be started. Once the engine has been started and is running, the blower fan switch 44 can be turned off allowing the engine to continue normal operation until the ignition switch 52 is turned off. Once the ignition switch 52 is turned off the above sequence must be repeated in order to restart the boat's engine. As a further safety measure, a bypass switch 54 has been provided to give the user the ability to circumvent the boat ignition safety apparatus 10 in the event of an emergency, This allows the user of the boat ignition safety apparatus 10 to immediately start the boat's engine to avoid potential danger—such as a head on collision. Additionally, in one example embodiment, when the bypass switch 54 is activated the blower motor 42 is automatically started.

FIG. 3 is a perspective view of a boat 112 equipped with the boat ignition safety apparatus 10 of the present invention with the engine compartment shown partially cut-away. Ordinarily, as a boat 112 is moving through the water, an adequate flow of fresh air is provided through the air inlet duct 110. However, when a boat is not being 10 operated, volatile gasoline fumes can accumulate over a period of time within the engine's compartment 98, providing an environment that is conducive for an explosion The present invention includes a ventilation fan 92 for evacuating contaminated air from the boat's engine compartment 98. Alternatively, ventilation fan 92 may be located in a remote location while being connected to exhaust ducting 108 in order to provide a ventilating flow of fresh air through the engine compartment 98.

Current federal regulations and safety guidelines suggest using a powered engine compartment ventilation system for at least four minutes before a boat is initially operated. Consequently, one object of the present invention is to assist in the reduction'” of boat explosions that result from the ignition of volatile fuel vapors that accumulate in the boat's engine compartment 98. To achieve this result, the present invention utilizes a number of sensing devices and timing relays. Specifically, apparatus 10 comprises an air pressure sensing switch 96 and timing relays contained in control module 94 to prevent engine ignition until air flow in the boat's engine compartment 98 has been established for a specified period of time.

The sequence of operation of the boat ignition safety apparatus 10 is initiated when the boat's user attempts to actuate the ignition switch 102. When this occurs, the control module 94 interrupts the ignition circuit and prevents the boat's user from being able to start the engine. The user must then turn on the ventilation fan 92, which provides positive air flow throughout the engine compartment 98.

In an alternate embodiment, control module 94 automatically turns on ventilation fan 92 upon detection of an attempt to actuate the ignition switch 102. The ventilation fan 92 dissipates any fuel fumes that may have accumulated in the boat's engine compartment 98 as a result of the boat not having been operated. An air pressure sensing switch 96 monitors the 11 flow of air via an air flow sensing tube 106 to ensure that clean, fresh air is being channeled through the engine compartment 98 by the ventilation fan 92. Once the air pressure sensing switch 96 determines that fresh air is entering the engine compartment, the electrical contacts of the air pressure sensing switch 96 are activated. The activation of the electrical contacts of air pressure sensing switch 96 initiates a timing circuit located within the control module 94, This timing circuit restricts the user from being able to start the boat's engine, as well as ensures that the ventilation fan 92 runs for a predefined period of time—four (4) minutes in one example embodiment. After a period of four (4) minutes has elapsed, the control module 94 completes the ignition circuit and illuminates the run indicator lamp 100 allowing the boat to resume normal operation. Once the engine has been started, the ventilation fan 92 can be turned off until the ignition switch 102 is again switched off.

To further enhance both boater and bystander safety, the present invention contains an emergency bypass switch 104. Emergency bypass switch 104 allows a user to immediately start the engine of the boat, thus avoiding the time required to complete the sequences of the boat ignition safety apparatus 10. Furthermore, when the emergency bypass switch 104 is activated the ventilation fan 92 is automatically started. This feature provides as much immediate ventilation to the engine compartment 98 as possible in the time allowed by any impending emergency, as some ventilation in an emergency is better than none

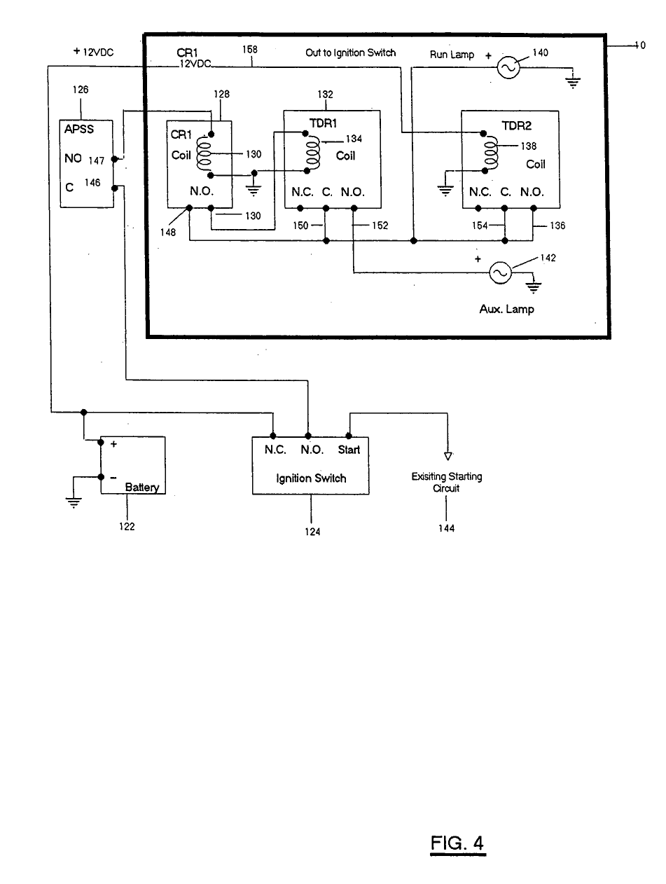

FIG. 4 is a schematic diagram of an alternate embodiment of the boat ignition safety apparatus 10. When the ignition switch 124 is initially activated, the +12VDC power source (battery) 122 is applied to the common contact C 146 of air pressures sensing switch (APSS) 126. The ignition switch 124 and the boat's existing starting 12 circuit 144 are then interrupted until the user activates the engine compartment ventilation fan 92 (see FIG. 3). In an alternate embodiment, apparatus 10 automatically engages the ventilation fan 92 when the ignition switch 124 is initially activated. When the ventilation fan is activated, +12VDC 122 is applied to air pressure sensing switch 126 causing common contact C 146 and normally open contact NO 147 of air pressure sensing switch 126 to close. The closing of common contact C 146 and normally open contact NO 147 results in +12V DC 122 being applied to coil 130 of control relay (CR1) 128. As a result, control relay 128 closes normally open NO contact 148 and! applies +12VDC 122 to time delay relay (TDR2) 136 and common contact C 150 of time delay relay (TDR1) 132. Time delay relays 132 and 136 initiate the timing cycle, which for example, is approximately four (4) minutes When the timing cycle is completed, time delay relay 132 closes common contact C 150 and normally open contact NO 152. Time delay relay 136 closes common contact C 154 and normally open contact NO 156 which applies +12VDC 122 to run light 140, ignition return path 158 and starting circuit 144, thereby allowing the engine to resume normal operation. Finally, the run light 140 is contained within the control module 94 (see FIG. 3) and the auxiliary light 142 terminals are provided for external connection to the control module 94.

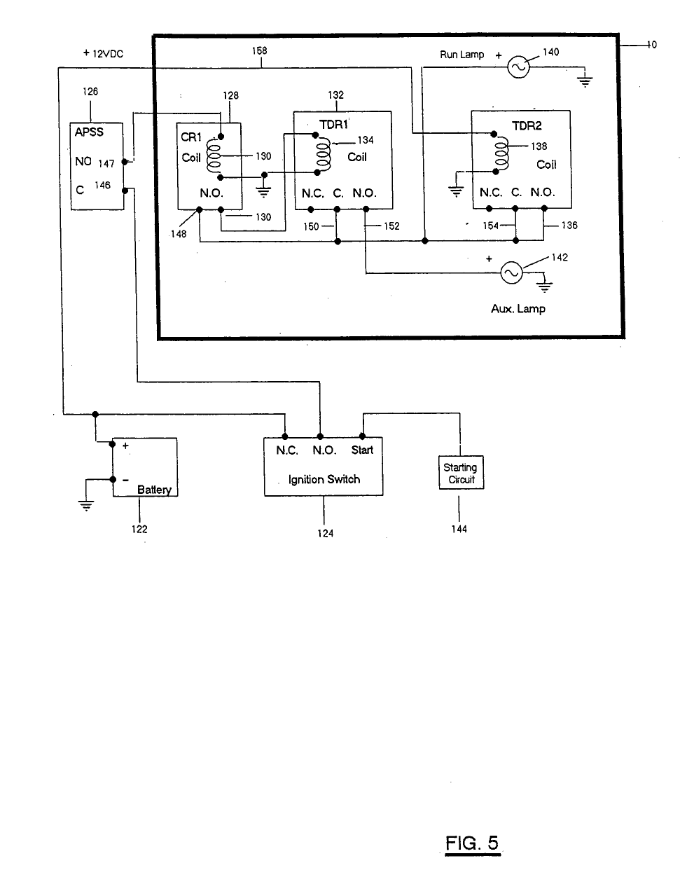

FIG. 5 is a schematic diagram of an alternate embodiment of the boat ignition safety apparatus 10, as shown in FIG. 4, depicting internal and external wiring connections. When the ignition switch 124 is activated, the +12VDC power source 122 is applied to common contact C 146 of air pressure sensing switch (APSS) 126. The ignition switch 124 and the starting circuit 144 are then interrupted until the user activates the engine compartment ventilation fan 92 (see FIG. 3). Once the user 13 initiates the engine compartment ventilation fan 92, the +12VDC power source 122 is applied to air pressure sensing switch 126, which causes common contact C 146 and +12VDC power source 122 being applied to coil 1'30 in control module (CR1) 128. As a result, the control module 128 closes normally open contacts NO 148 and applies the +12VDC power source 122 to time delay relay TDR2) 136 and common contact C 150 of time delay relay TDR1) 132. Time delay relays 132 and 136 initiate the timing cycle, which for example, is approximately four (4) minutes. When the timing cycle is completed, time delay relay 132 closes common contact C 150 and normally open contact NO 152. Time delay relay 136 closes common contact C 154 and normally open contact NO 156, which applies the +12VDC power source 122 to run light 140 and starting circuit 144. This in turn allows the boat's engine to resume normal operation. Finally, the run light 140 is contained within the control module 94 (see FIG. 3) and the auxiliary light 142 terminals are provided for external connection to: the control module 94.

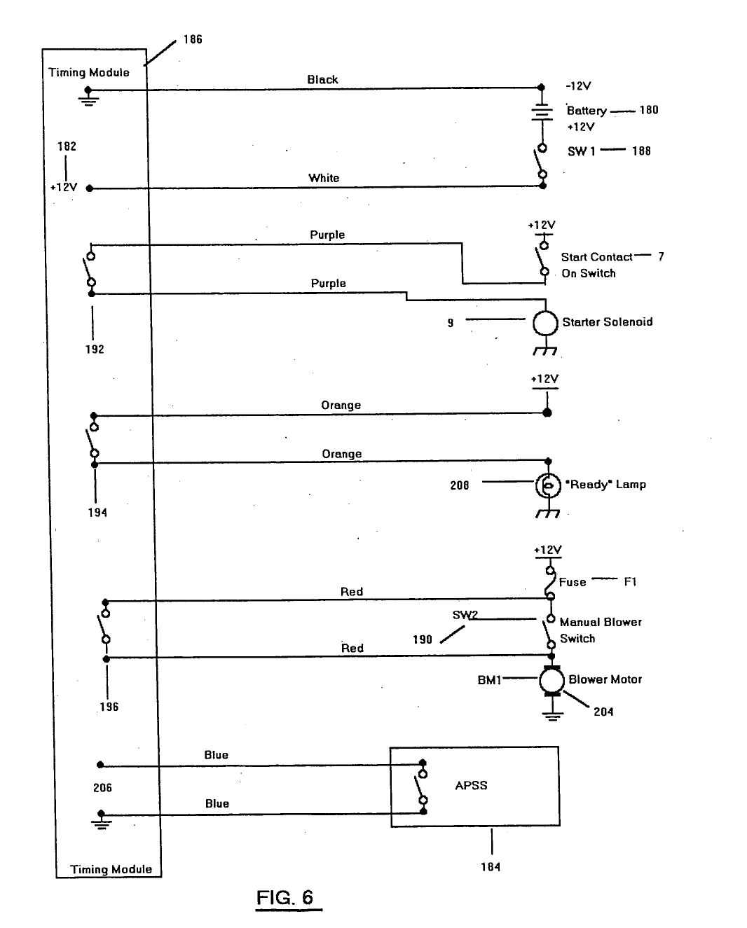

FIG. 6 refers to an alternate embodiment of the boat ignition safety apparatus. The alternate embodiment is comprised of a timing module 186, which controls the functions of the boat ignition safety apparatus. Although not show, timing module 186 can be comprised of electro-mechanical relay logic, solid state and digital switches, or microprocessor or microcontroller circuitry. The use of digitally programmable control devices allows for advanced monitoring of air flow, reprogrammable time delays, and more versatile control of the engine. A person of ordinary skill in electronics would know that there are many ways to implement the control functions of the present invention and would be able to do so based upon the descriptions set forth herein. Therefore, FIG. 6 and several other figures disclose the functions of the present invention in the form of a timing module, which is an electrical or electronic black box for performing the recited functions.

When timing module 186 is actuated it receives +12VDC power 182 via switch 188, and battery 180, which causes internal switches 192 and 194 to open, and internal switch 196 to close, disabling the boat's ignition and starter circuits. Internal switch 196 starts the boat's ventilation fan or blower motor BM1 204. The blower motor 204 provides air flow in the engine compartment and creates positive air pressure within the engine compartment. When the air pressure sensing switch (APSS) 184 detects the positive air pressure it opens its contacts. The air pressure sensing switch 184 also removes the ground potential from internal connection 206 and starts the timing cycle. The timing cycle will continue for approximately four (4) minutes or some other predetermined time period,

If the boat's operator fails to turn on the manual blower switch SW2 190 before the timing cycle completes, the blower motor 204 stops, which in turn allows the positive air pressure within the engine compartment to dissipate. The air pressure sensing switch 184 detects the change in air pressure and opens its contacts preventing the boat's engine from starting. The timing cycle must be reset by turning off SW1 188 or by turning on the manual blower switch SW2 190.

When the timing cycle is reset and the blower motor 204 is turned on by the boat's operator, the timing cycle will continue to run for four (4) minutes plus or minus three (3) seconds. When the timing cycle completes and ready lamp 208 is illuminated, the boat's engine is running the blower motor 204 may be turned off and the boat's engine will resume normal operation Once the boat's engine resumes normal operation, the blower motor 204 may be turned on/off as needed.

Additionally, the boat's operator also has the option in an emergency to by-pass the timing module 186 by activating an emergency by-pass switch (not shown) allowing the boat's engine to be started immediately. This can be advantageous in that it allows the boat operator to avoid a collision or other source of danger.

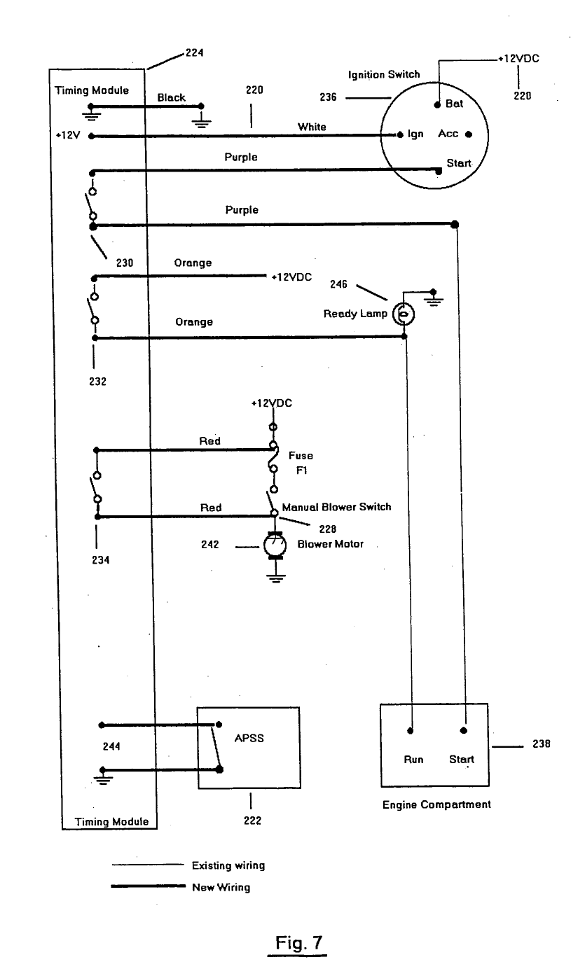

FIG. 7 is a schematic diagram of an alternate embodiment of the boat ignition safety apparatus of the present invention. The boat ignition safety apparatus is comprised of a timing module 224, that when actuated, receives +12VDC power 220 supplied via the boat's ignition switch 236 which causes internal switches 230 and 232 to open, and internal switch 234 to close, disabling the boat's ignition and starter circuits 238. Internal switch 234 starts the boat's blower motor BM1 242. The blower motor 242 creates positive air pressure within the engine compartment, which is detected by the air pressure sensing switch (APSS) 222. As a result the air pressure sensing switch 222 opens its contacts and removes the ground potential from internal connection 244, thereby starting the four (4) minute timing cycle, If the boat's operator fails to turn on the manual blower switch 228 before the timing cycle completes, the boat's blower motor 242 stops, which causes the air pressure sensing switch 222 to open its contacts thereby preventing the boat's engine from starting In addition, the timing cycle must be reset by turning off the boat's ignition switch 236, or by turning on the manual blower switch 228.

When the timing cycle is reset and the blower motor 242 is turned on by the boat's operator, the timing cycle will continue to run for approximately four (4) minutes. When the timing cycle completes and ready lamp 246 is illuminated the boat's ignition and starter circuits 238 are enabled and the engine may be started Once the boat's engine is running the blower motor 242 may be turned off and the boat's engine will resume normal operation Once the boat's engine resumes normal operation the blower motor 242 may be turned on/off as needed.

Additionally, the boat's operator again has the option in an emergency to by-pass the timing module 224 by activating an emergency by-pass switch (not shown) allowing the boat's engine to be started immediately.

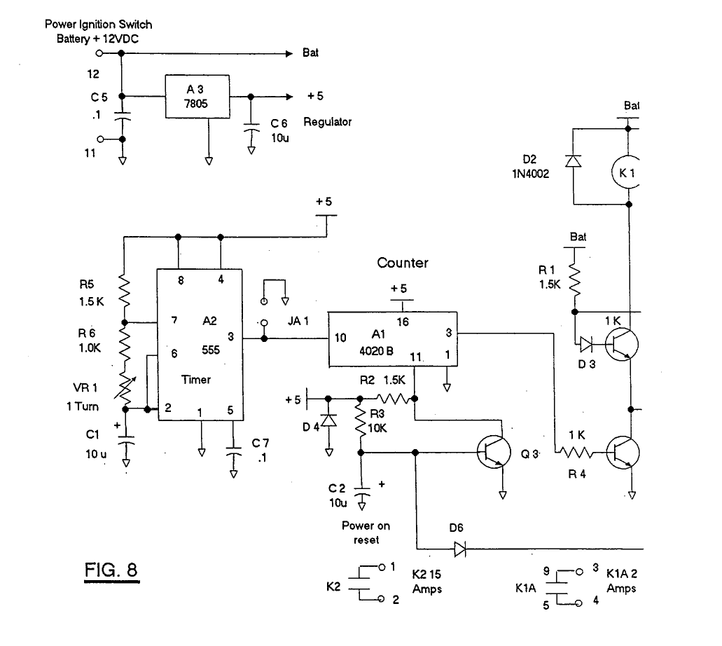

FIG. 8. is a schematic diagram of an electronic circuit implementing an alternate embodiment of the boat ignition safety apparatus. Power is applied to the circuit through the boat's ignition switch with 12 VDC applied across pins 11 and 12 of the circuit. A 5 VDC regulator (A3) 250 produces a regulated +5 volts to the timing and control circuitry. With power applied, a precision timer (A2) 252 begins to produce clock pulses and binary counter (A1) 254 is reset due to a high logic level at pin 11. This high “-logic level is created by the power on reset delay circuit, which is comprised of transistor (Q3) 256 and the resistive-capacitive network (C2-R2) 258-260. If pins 7 and 8 are maintained at ground potential, the reset condition for the disclosed electronic circuit will continue.

While the circuit is reset, pin 3 will remain at a low logic level, which prevents relays K1 (262) and K2 (264) from energizing In turn, this inhibits ignition and prevents starter motor power. Turning on the boat's ventilation fan and/or blower motor creates positive air pressure within an engine compartment, which air pressure sensing switch (external to circuit shown in FIG. 8) detects and forces pins 7 and 8 to a positive potential If pins 7 and 8 are at a positive potential greater than 2 volts, delay capacitor (C2) 258 charges until it reaches approximately 0.7 VDC, and transistor (03) 256 conducts, which applies a low logic level on the reset input (pin 11) to counter (A1) 254, allowing counter operation to begin timing.

Counting continues until the instant 16,384 counts are registered and pin 3 of counter (A1) 254 goes high. With pin 3 high, transistors (Q1) 268 and (Q2) 266 will conduct, relays (K1) 262 and (K2) 264 will activate, thereby enabling the ignition and starter motor power when selected. Contact K1C (not shown) provides a latch so that additional clock pulses do not effect the enabled status of the circuit. Relay contacts (K2) 270, (K1A) 272 and (K1 D) 274 close during the enabled status. The nominal time from end of reset to enabled status is approximately 4.1 minutes. Reset may be initiated at any time by grounding pins 7 and 8 for approximately 0.5 seconds or more. Timing will begin when the grounding of pins 7 and 8 is removed

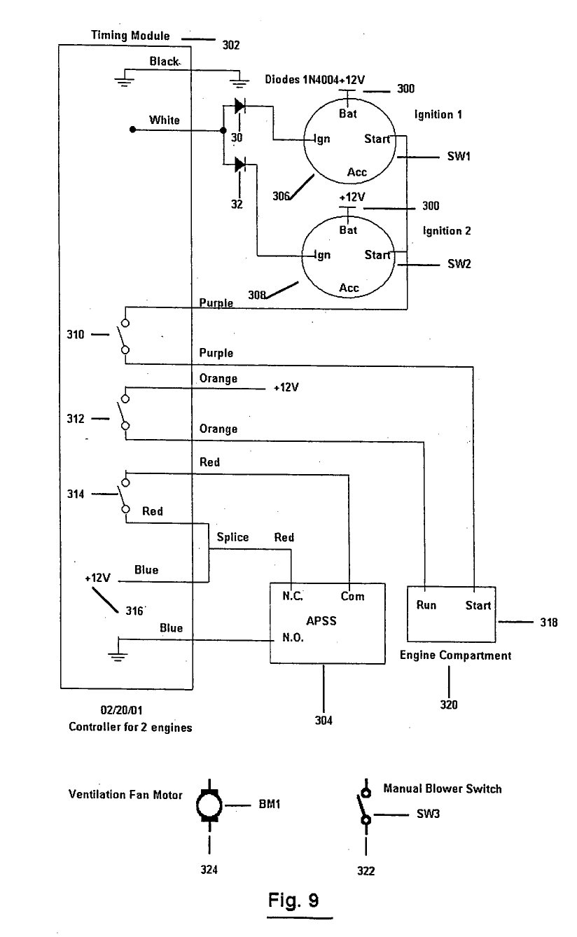

FIG. 9 is a schematic diagram of an alternate embodiment of the boat ignition safety apparatus for use in boats having multiple engines. When ignition switches 306 308, or the ignition switches for both engines are activated, +12VDC power 300 is supplied to the timing module 302, which causes internal switches 310 and 312 to open, and internal switch 316 to close, disabling the ignition and starter circuits 318 in the engine compartment 320. The internal switch 316 remains closed until the boat's operator turns on the boat's manual blower switch SW3 322, which starts the boat's ventilation fan or blower motor 8M 1 324. The blower motor 324 creates positive air pressure within the engine compartment sensed by the air pressure sensing switch (APSS) 304. This causes air pressure sensing switch 304 to open its contacts and remove the ground potential from the internal connection 316, which starts the timing cycle. The timing cycle will continue for approximately four (4) minutes or some other predetermined time period If the boat operator turns off the manual blower switch SW3 322 or the air pressure is interrupted before the timing cycle completes, the air pressures sensing switch 304 will detect the change in air pressure and close its contacts. This in turn will stop the timing cycle and reset the timer to zero, This will continue until the air pressure sensing switch 304 detects that the air pressure has been restored Until the positive air pressure is restored, the ignition and starter circuit 318 will remain disabled

When the timing cycle is reset by restoring positive air pressure within the engine compartment, the air pressure sensing switch 304 closes its contacts and restarting the timing cycle for four (4) minutes. When the timing cycle completes, the ignition and starter circuit 318 is enabled, the engines may be started Once the engines are running, the boat's blower motor 324 may be turned off. This causes the contacts on switch 314 to open thereby removing the ground potential at the internal connection 316 and allowing the engines to resume normal operation. Additionally, the boat's operator again has the option in an emergency to by-pass the timing module 302 by activating an emergency by-pass switch (not shown) allowing the engines to be started immediately.

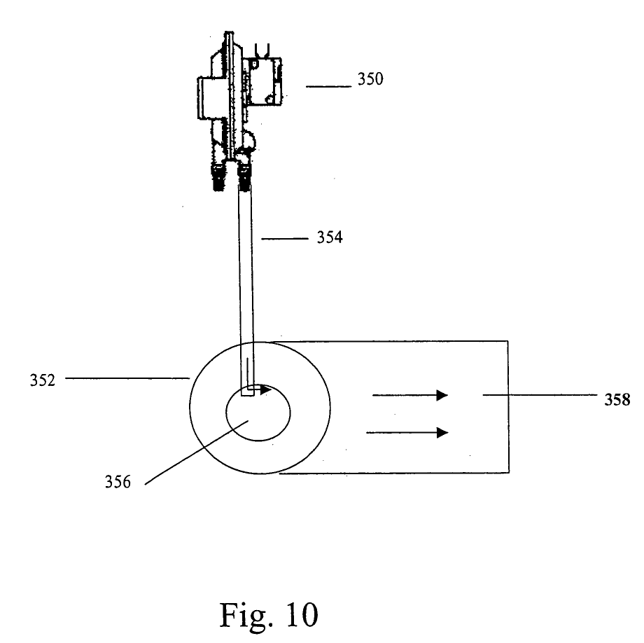

FIG. 10 is an elevational view illustrating the functionality of the air pressure sensing switch (APSS) 350. The air pressure sensing switch 350 may be located at any given location within the hull of a boat (see FIG. 3, 112) as long as the air pressure air pressure, within the air pressure sensing tube 338 thus activating the contacts in the 350 is preconfigured to sense the negative air pressure created at the blower motor 352.

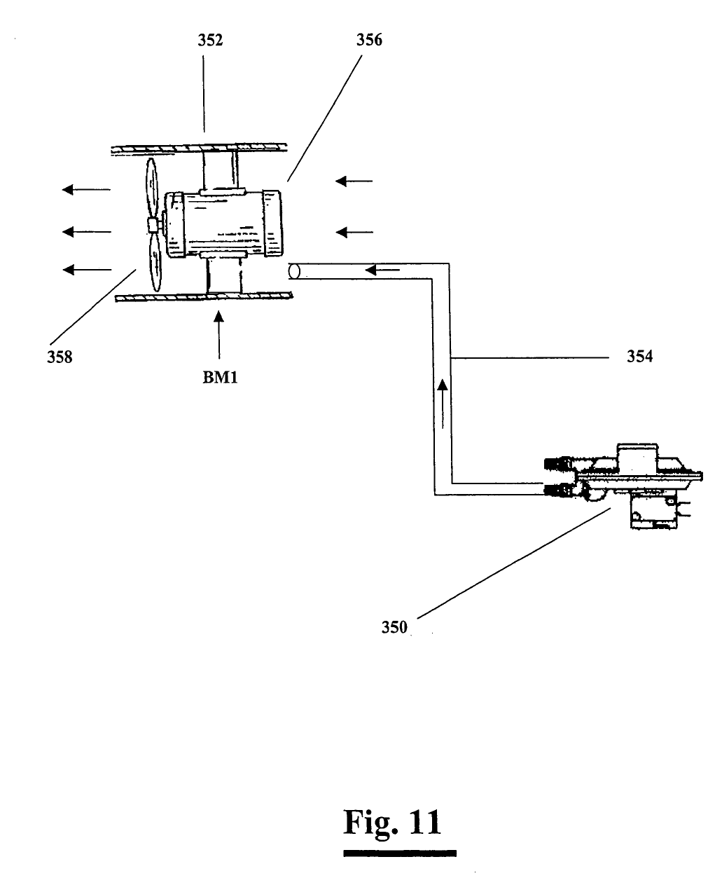

FIG. 11 is an elevational view illustrating the functionality of the air pressure sensing switch (APSS) 350 when used with an in-line blower motor 352. The air pressure sensing switch 350 may be located at any given location within the hull of a boat (see FIG. 3, 112) as long as the air pressure sensing tube 354 is located near the bottom of the engine compartment and above the normal bilge water line. When the in-line blower motor 352 is running, air enters through the air inlet 356 and exits through the air outlet 358, which creates negative air pressure within the air pressure sensing tube 354 thereby causing the air pressure sensing switch 350 to activate its contacts. This embodiment also takes advantage of negative air pressure rather than the earlier embodiments which monitor positive air pressure within the engine compartment.

In an alternate embodiment, the air pressure sensors 96 are replaced with vapor sensors, or in the alternative both air pressure sensors 96 and vapor sensors are positioned within the engine compartment 98. The air pressure sensors are used to determine whether there is an adequate flow of air within the engine compartment 98, verifying that the exhaust or ventilation fan 92 is operating properly. The vapor sensors are used to monitor the amount of volatile gas fumes within the engine compartment 98, determining whether to turn the ventilation fan 92 on or off. Typically, the vapor sensors would be positioned in any operative location within the engine compartment and above the normal bilge water line.

In this embodiment, the boat ignition safety apparatus is initiated when the boat's user attempts to actuate the ignition switch. When this occurs, the control module interrupts the ignition circuit and prevents the boat's user from being able to start the engine. Additionally, upon detection of an attempt to actuate the ignition switch, the control module then automatically turns on the exhaust or ventilation fan 92. The ventilation fan dissipates any fuel fumes that may have accumulated in the boat's engine compartment as a result of the boat not having been operated. Once activated, the exhaust or ventilation fan 92 will run for a predetermined time delay, maintaining the flow of fresh air through the engine compartment 98. During the predetermined time delay, the engine of the boat is disabled and may not be started.

Once the predetermined time delay expires, the vapor sensors are activated, to monitor the amount of volatile gas fumes within the engine compartment. If the vapor sensors do not detect volatile gas fumes, the control module enables the ignition and starter circuits, allowing the boat's engine to be started. Once the engine is started, the ventilation fan will continue to run for another predetermined period of time, or it may be manually turned off by the boat's user.

If volatile gas fumes are detected by the vapor sensors, the control module continues the interruption of the ignition and starter circuits and the user is prevented from starting the engine. Generally, unless their is no detection of volatile gas fumes after the predetermined time delay, the engine will not be allowed to start. When this occurs, the exhaust or ventilation fan 92 would then be re-activated, and would continue to run until the volatile gas fumes have been cleared.

Other variations are also contemplated within the scope of the present invention. For example, in lieu of relay logic in the form of electro-mechanical and time delay relays as illustrated, solid state and digital switches could be used. Additionally, the present invention may also be designed around microprocessor or microcontroller circuitry. The use of digitally programmable control devices would allow for advanced monitoring of air pressure and air flow, reprogrammable time delays, and more versatile control of the engine. The use of microprocessor technology, in conjunction with standard memory, communication and input/output devices, will also allow the boat ignition safety apparatus to monitor and store statistics related to its operation such as air pressure, air flow, use of the by-pass switch, failures, and other conditions. One of ordinary skill in the art of electronics will understand that a wide variety of data acquisition functions can be implemented using microprocessor technology, including but not limited to data storage, printing of monitored data, and wire/wireless transfer of information.

One or more embodiments of the present invention could also be used in conjunction with other types of machines in which fumes accumulate in enclosed or partially enclosed compartments. For example, the present invention could be used in conjunction with automobiles, aircraft, electrical panels that house gaseous emitting battery supplies, and other uses. The present invention can be adapted for use in any situation in which fumes need to be evacuating from an enclosed environment before further operations within that enclosed environment are undertaken.

Thus, while the form of the apparatus and method herein described constitutes the examples or embodiments of this invention, it is to be understood that the invention is not limited to these precise forms of the disclosed apparatus and methods, and that changes may be made therein without departing from the scope of the invention.

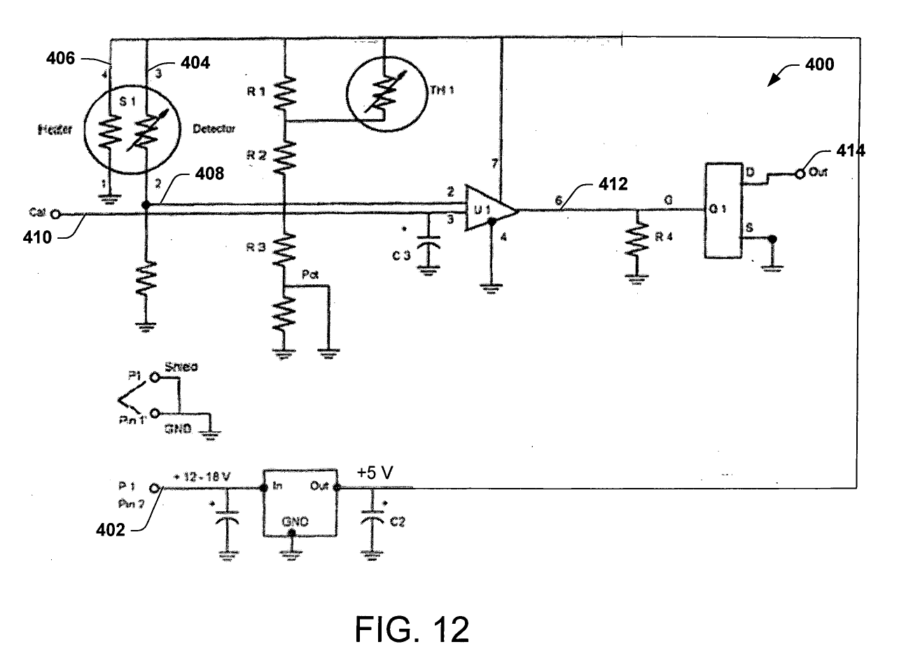

FIG. 12 depicts an example of a circuit diagram of a vapor sensor circuit 400 that can be implemented according to an aspect of the present invention. The vapor sensor 400, for example, can be implemented as part of the safety apparatus shown and described above. For example, the sensor circuit 400 is designed for use in a marine engine room environment, and can be implemented to provide substantially fail safe operation, and temperature compensation to achieve desired performance.

For purposes of illustration, the following example assumes the following initial conditions:

1. Automatic ignition safety delay system with fuel vapor detector installed.

2. Ignition switch OFF for more than 2 hours

3. Safe level of fuel vapor in engine space.

4. No power is available to the vapor circuit

When the water craft ignition switch is moved to the ON position, available DC voltage (e.g., about 12 volts) will be applied to pin 402 of plug PI. Additionally, a regulated voltage (e.g., of about +5 V) is available to the circuit from stable voltage regulator VR, which can be associated with capacitors C1 and C2 coupled at the respective inputs and outputs of VR. The regulated voltage of about +5V is applied to inputs 404 and 406 of a sensor S1, as well as to a thermistor TH1, R1 and a comparator U1. The thermistor TH1 is coupled between R1 and R2. R1 and R2 are connected in series with resistor R3 between the regulated +5V resistor and ground through an associated pot. Thus, the thermistor and R1 experience a common voltage potential according to the relative resistances provided by the voltage divider circuit formed of R1, R2, R3 and the pot.

In one example, the sensor SI includes a metal oxide surface which adsorbs combustible vapors or gas. The more gas (per unit volume of air) the higher the detector temperature and electrical conduction. The comparator UI can also include a built-in heater (not shown) to increase sensitivity and rate of vapor detection.

With power applied, the sensor SI starts heating as does the thermistor TH1 (e.g., implemented as a sealed metal oxide device). The sensor S1 and thermistor TH1 will be ready to work as a temperature compensated Wheatstone bridge circuit after power has been applied for a sufficient period of time (e.g., about 10 to 30 seconds). The particular amount of time for such pre-heating of the sensor and thermistor can vary according to the ambient temperature and humidity.

Comparator UI has two voltage inputs, such as a negative input at 408 and a positive input at 410. The input at 408 corresponds to an output of S1 and is coupled to ground through a resistor RL. Characterization resistor value for RL can be supplied by the vendor of the sensor S1. The higher positive pin determines the comparator output at 412. With low level fumes, for example, the comparator input at 408 will be lower than at the input 410, and the comparator output at 412 will be high, causing Q1 to conduct. This results in the output terminal 414 of Q1 being placed at ground potential. This, in turn, can be supplied to notify an associated controller (e.g., via a connecting cable) that vapor fumes are not present in the engine room in the proximity of the sensor. Thus, the engine can be started.

In a situation when high level fumes are present, the voltage at the input 408 is greater than at the input 410, causing comparator U1 output at 412 go to ground. This, in turn, drives the drain of Q1 open at 414. This condition notifies the controller through the connecting cable at 414 of the presence of gas in the sensor area.

The input 410 of the comparator U1 corresponds to a calibration input that provides a compare reference with a factory adjustment POT. The metal oxide thermistor TH1 and resistor network complete the bridge circuit, adding ambient temperature compensation. For example, as air temperature rises at the sensor S1, the voltage rises at the input 408 (due to sensor operation), but so does the voltage at 410 due to operation of the thermistor TH1. Thus, the thermistor TH1 and the sensor S1 cooperate to mitigate effects of ambient temperature and enable improved vapor detection over a wide temperature range.

The output 414 will be at ground potential, which indicates the presence of fumes at or below the nominal factory set (via POT) condition, such as about 15% Lower Explosive Limit (LEL).

If the engine space gas level rises above nominal 15% LEL, then Q1 is activated to open the output at 414, which notifies the controller to activate an associated alarm program, such as described herein.

Additional precautions can be provided by the circuit 400 by enabling an alarm if (1) any probe wire(s) is disconnected to controller and/or (2) probe cable is disconnected from the controller.

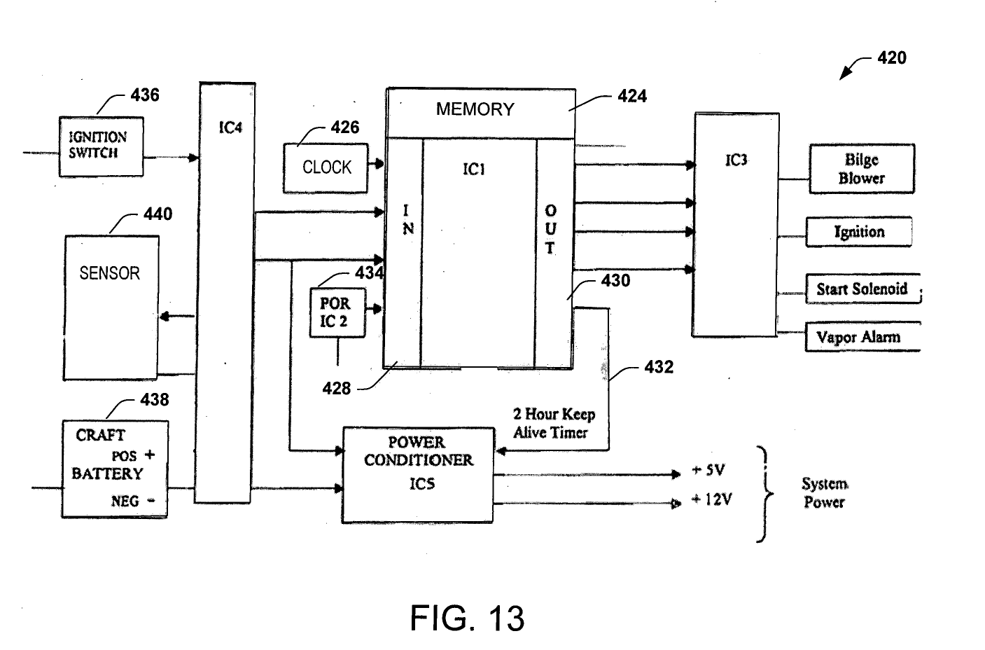

FIG. 13 depicts a block diagram of a boat ignition safety apparatus 420 that can be implemented according to an aspect of the present invention. The apparatus includes a controller 422. The controller includes a microprocessor IC1. In the example of FIG. 13, IC1 includes onboard Read Only Memory (ROM) 424 that contains the control program for this device. Those skilled in the art will understand how to program the ROM 424 based on the teachings contained herein. IC1 also includes associated Random Access Memory (RAM) for computing and temporary storage and a clock (e.g., a quartz clock) 426 for stable timers. In and out buffers 428 and 430, respectively, also are utilized to communicate with the craft components. The controller 422 also includes a Watch Dog timer, schematically indicated at 432, which initializes if computing erroneously stops. A power on reset (POR) unit is operative to initialize the microprocessor IC1.

The electrical connections between the controller 422 and associated devices and components in the system 420 are made through associated conditioner/isolating components indicated at IC3 and IC4. For example, IC3 provides drive for the system relays, isolation as well as suppression for relay contacts associated with, for example, the bilge blower, ignition, start solenoid and associated vapor alarm. IC4 filters input signals, and isolates via associated opto-couplers. IC4 also provides power to the power conditioner IC5 when the ignition switch 436 is first turned ON.

The power conditioner IC5 filters the craft battery power from battery 438 and provides desired regulated voltages for system operation. For example IC5 is tasked with providing initial system start-up power, then connects the system directly to “craft battery” 438 during normal operation. IC5 also maintains the craft battery connection for a predetermined period of time after the ignition switch 436 is turned OFF. For example, ICI can control the power conditioner ICI5 to maintain the battery connection for a desired period of time to enable operation of an associated vapor sensor circuitry 440, such as described herein. The time period can be about 2 hours or other period of time deemed appropriate, which can be fixed or be programmable.

When preparing to start the boat's engine, the first step is to turn on the boat's ignition switch 436. When the boat's ignition switch is activated, desired voltage (e.g., 12 V) is applied to the POR 434. IC2 sends a signal to IC1 to initialize the microprocessor. IC1 initializes IC3 which provides drive for the system relays, isolation, and arc suppression for relay contacts and activates IC4. As mentioned above, IC4 filters input signals, including those from the sensor 440 and isolates via opto-couplers. IC4 also provides power to the power conditioner IC5 when the boat's ignition switch is first turned ON. ICS filters the craft battery power 438 and provides the regulated voltage needed for the system.

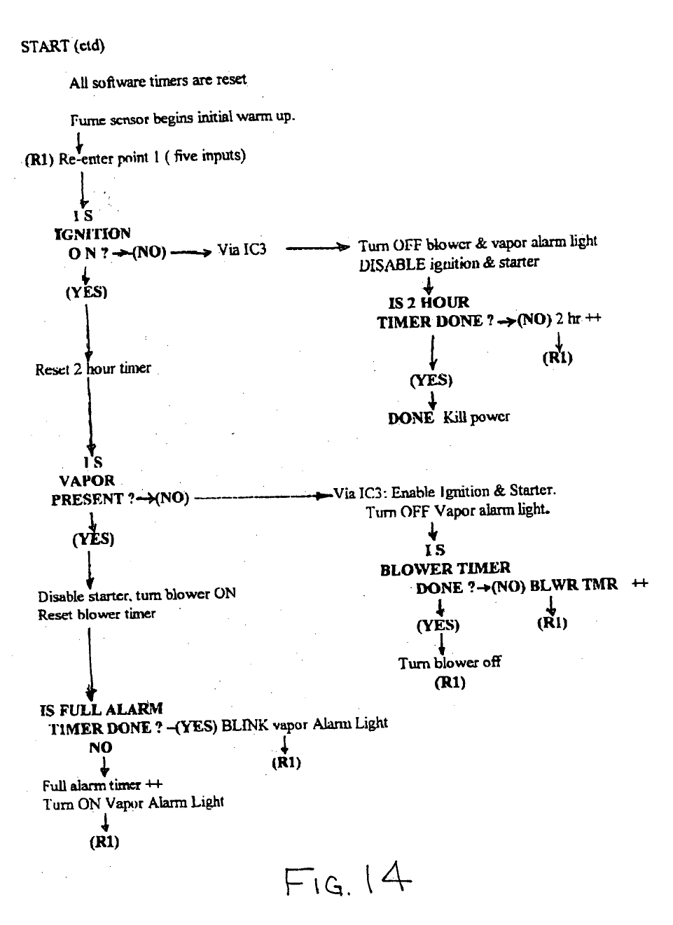

FIG. 14 is a flow diagram depicting an example method that can be implemented according to an aspect of the present invention, such as by the system of FIG. 13. In general, the methodology enables the ignition and starter if a determination is made that no vapors are present. The determination can be made by a controller based on a signal from a vapor sensor, such as described herein. If vapors are present, the engine starter can be disabled and blower activated to an ON condition.

Additionally, after the ignition is turned off, a timer is activated for a predetermined duration (e.g., 2 hours) during which the bilge blower motor can be selectively activated (e.g., by the controller). Also, the vapor sensor can be activated to sense vapor within the engine compartment. In this way, the blower can be activated based on detecting vapor or fumes within the engine compartment even after the ignition has been turned off. That is, the methodology enables the ignition and engine operation during the period controlled by the timer so long as vapors are not detected. Further because fumes can be exhausted by the blower while the ignition is off (based on the vapor sensor for a duration based on the timer), the delay typically needed to vent (or exhaust) fumes prior to starting the engine can be significantly reduced or even eliminated altogether. This is useful in a situation when a boat ignition is turned off and a prompt start is desired.

After the blower timer has timed out, the blower is turned off. Otherwise, the methodology can repeat, as indicated in FIG. 14. An optional emergency safety override feature further can be used to enable the operator to start the engine even if the ignition has been disabled by the controller based on the vapor sensor.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A system to facilitate safe operation of a vehicle, comprising:
a vapor sensor operative to detect fumes within an associated compartment;
a blower operatively associated with the compartment to facilitate venting gas therefrom; and
a controller that controls the blower based on the amount of vapor fumes detected by the vapor sensor.

2. The system of claim 1, the controller provides a control signal to one of enable and disable an associated engine based on the amount of vapor fumes detected by the vapor sensor.

3. The system of claim 2, the controller maintains operation of the vapor sensor for a predetermined period of time after an associated ignition has been turned off to enable control of the blower during the predetermined period of time after the associated ignition has been turned off based on the amount of vapor fumes detected by the vapor sensor.

4. A method to control starting a marine vehicle, comprising:
activating a timer in response to an ignition switch being turned off;
sensing fumes within a compartment of the marine vehicle; and
controlling ignition of the vehicle based on the sensing of fumes and the timer.

5. The method of claim 4, further comprising controlling a blower to exhaust at least some of the fumes from the compartment of the marine vehicle based on the sensing of vapors and based on the condition of the ignition switch.

6. The method of claim 5, further comprising enabling operation of the blower and the sensing of fumes for a predetermined duration provided by the activated timer.

7. A system to facilitate venting fumes from an engine compartment of a marine vehicle, comprising:
means for activating a timer in response to an ignition switch being turned off;
means for sensing fumes within a compartment of the marine vehicle; and
means for controlling a blower to exhaust at least some of the fumes from the compartment of the marine vehicle based on the sensing of vapors and based on the the timer.
